(19) United States
(12) Patent Application Publication
(10) Pub. No.: US 2005/0223838 A1
(43) Pub. Date: Oct. 13, 2005

(54) Method of assembling steering columns

(75) Inventors: Kiyoaki Higashino, Gunma-ken (JP); Tetsuya Koike, Gunma-ken (JP)

Correspondence Address: CROWELL & MORING LLP;INTELLECTUAL PROPERTY GROUP, P.O. BOX 14300, WASHINGTON, DC, 20044-4300, US

(73) Assignee: NSK LTD., TOKYO (JP)

(21) Appl. No.: 10/511,149

(22) PCT Filed: Feb. 19, 2003
(86) PCT No.: PCT/JP03/01782

§ 371 Date: Apr. 28, 2005

(30) Foreign Application Priority Data
Apr. 17, 2002 (JP) 2002-114121

(51) Int. Cl. B62D 1/16

(52) U.S. Cl. 74/492

(57) ABSTRACT

A method of assembling steering columns. The assembling method includes the steps of forming a cylindrical column jacket 3, forming a pair of joint projections 4a and 4b comprising inner surfaces 4c and 4d conforming to an outer surface 3a of the column jacket 3 on a distance bracket 4, temporary fitting the projections 4a and 4b of the distance bracket 4 to the outer surface 3a of the column jacket 3, and crimping the projections 4a and 4b into the outer surface 3 of the column jacket 3.

### TECHNICAL FIELD

The present invention relates to steering columns for vehicle, in particular to a method of assembling steering columns, for fixing a bracket to a column jacket by crimping joint projections which are integrally formed with the bracket main body.

### BACKGROUND ART

Brackets such as column brackets, tilt brackets and the like are provided on steering columns for a vehicle. Fusion welding whereby a large joint strength can be obtained, is used for fixing such brackets to the column jacket, except for a part of the brackets. The usage of welded brackets greatly contributes to lightening of the steering column, simplifying the processes, and decreasing the manufacturing cost. Having such advantages, on the other hand however, the usage of the weld brackets is also accompanied with disadvantages such as the deformation of the column jacket due to the heating at the time of welding, or the generation of greenhouse effect gas such as carbon dioxide due to the welding fumes.

Incidentally, regarding the steering column, there has been an attempt to replace the weld brackets by non-weld brackets. The non-weld brackets include for example, brackets fixed using fasteners such as a rivet or pin, and brackets fixed by press fitting without fasteners therebetween.

However, when fixing the brackets using fasteners such as a rivet or pin, punches for piercing the fasteners are required for the column jacket and the brackets, which increases the number of steps and the number of components, causing an increase in the manufacturing cost. On the other hand, when fixing the brackets by press fitting, although it is possible to avoid the increase in the number of components or the like, it is difficult to keep the dimension of the inner diameter of the bracket within the determined tolerance to obtain the proper interference, and the accuracy is not easily controlled.

An object of the present invention is to provide a method of assembling steering columns which enables the brackets to be securely fixed to the column jacket using simple joint components only.

### DISCLOSURE OF INVENTION

A preferred aspect of the present invention includes the steps of forming a cylindrical column jacket, forming a pair of joint projections comprising inner surfaces in a circular arc shape conforming to an outer surface of the column jacket on a bracket, temporary fitting the projections of the bracket along the outer surface of the column jacket, and crimping the projections into the outer surface of the column jacket.

Furthermore, another aspect includes the steps of forming a cylindrical column jacket, forming a pair of flat surfaces back to back on an outer surface of the cylindrical column jacket, forming a pair of joint projections comprising flat inner surfaces conforming to the pair of flat surfaces of the column jacket on a bracket, temporary fitting the projections of the bracket along the flat surface of the column jacket, and crimping the projections into the flat surface of the column jacket,

According to the present invention, since the bracket with the joint projections integral with the main body is fixed by crimping, the number of steps and the number of components are not increased, as is the case of fitting using fasteners, and the manufacturing cost can be kept from increasing.

Moreover, it is not necessary to strictly control the accuracy of the dimension of the inner diameter of the bracket, as is the case of fixing by press fitting, so that the bracket can be manufactured at low cost.

Furthermore, since the bracket is not jointed by welding, the column jacket is not deformed and the quality can be kept stable. On the other hand, welding fumes are not generated, so there can be no generation of greenhouse effect gas such as carbon dioxide.

### BRIEF DESCRIPTION OF THE DRAWINGS

FIG. 1 is a cross-sectional view showing a steering column comprising a distance bracket according to the present invention.

FIG. 2 is a schematic diagram showing a step for forming a column jacket and an upper bracket, a step for temporary fitting the distance bracket to the column jacket, and a step for crimping projections, according to the present invention.

FIG. 3 is a front view showing a steering column comprising an upper bracket, according to the present invention.

FIG. 4 is a schematic diagram showing a step for forming a column jacket and an upper bracket, according to the present invention.

FIG. 5 is a schematic diagram showing a step for temporary fitting the upper bracket to the column jacket, and a step for crimping projections, according to the present invention.

FIG. 6 is a schematic diagram showing a step for crimping projections of a lower bracket, according to the present invention.

FIG. 7 is a schematic diagram showing a step for crimping projections of a bracket, according to the present invention.

### BEST MODE FOR CARRYING OUT THE INVENTION

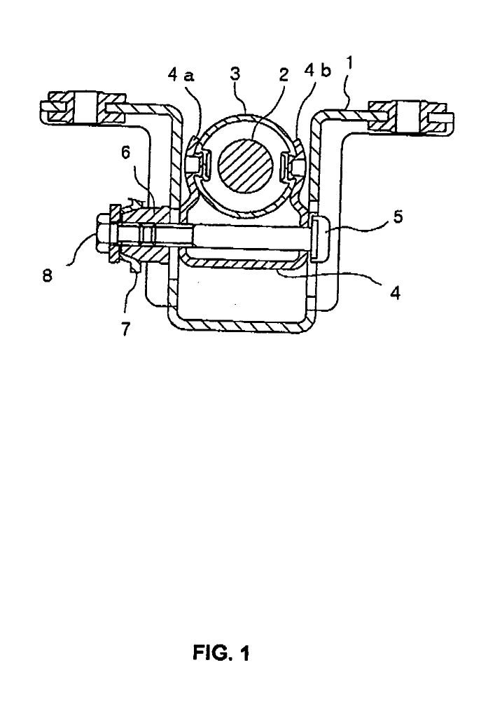

Hereunder is a detailed description of the present invention with reference to the appended drawings. The present embodiment is an application example for a distance bracket which is used together with a tilt bracket. In FIG 1, a tilt bracket 1 fixed to a body member (not shown) is a member which supports a column jacket 3 containing a steering shaft 2. A distance bracket 4 is mounted in the center of the tilt bracket 1. The column jacket 3 is held between a pair of joint projections 4a and 4b of the distance bracket 4. A tilt bolt 5 being a fastening member, is provided through the tilt bracket 1 and the distance bracket 4. A nut 6 is screwed to a thread part at the tip of the tilt bolt 5.

On the other hand, a tilt lever 7 for fastening the fastening member, is engaged with the nut 6. The tilt lever 7 comprises a bolt 8 for fixing a part thereof to the nut 6.

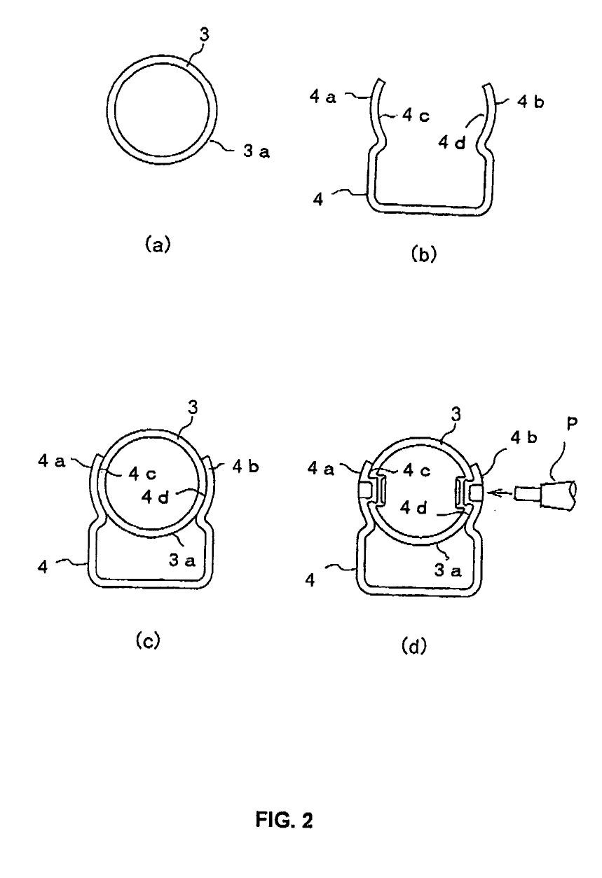

Hereunder is a description of a method of assembling a steering column based on the schematic diagram shown in FIG. 2. An electric resistance welded mild steel tube or a drawn tube is cut in a predetermined length to form a cylindrical column jacket 3 comprising a circular outer surface 3a shown in FIG. 2(a).

As shown in FIG. 2(b), a mild steel plate is prepared and press processed into the distance bracket 4 comprising the pair of joint projections 4a and 4b. The pair of projections 4a and 4b are symmetrically formed with respect to the center of the distance bracket extending in the same direction. Inner surfaces 4c and 4d of the projections 4a and 4b are formed in a circular arc shape conforming to the outer surface 3a of the column jacket 3.

As shown in FIG. 2(c), the distance bracket 4 having the projections 4a and 4b is fitted to the column jacket 3 which was previously processed. In the present step, the inner surfaces 4c and 4d of the projections 4a and 4b are fitted along the outer surface 3a of the column jacket 3. After assembling, they are temporary fixed using a suitable clip so that the position of both members does not change accidentally. The arrangement may be such that the distance bracket 4 is temporary fixed to the column jacket 3 by the spring back generated between the projections 4a and 4b.

As shown in FIG. 2(d), while supporting the inner surface of the column jacket 3 by a die (not shown), the outer surfaces of the projections 4a and 4b of the distance bracket 4 are crimped by applying a punch P. In the present step, these are crimped with the punch P which is pressed toward the center of the column jacket 3 so as not to deform the circular cross-section column jacket 3. By the above procedure, the steering column having the distance bracket 4 mounted thereon (refer to FIG. 1) is obtained.

In the present embodiment, since the bracket with the joint projections integral with the main body is fixed by crimping, the number of steps and the number of components are not increased, as is the case of fitting using fasteners, and the manufacturing cost can be kept from increasing.

Moreover, it is not necessary to strictly control the accuracy of the dimension of the inner diameter of the bracket, as is the case of fixing by press fitting, so that the bracket can be manufactured at low cost.

Furthermore, since the bracket is not jointed by welding, the column jacket is not deformed and the quality can be kept stable. On the other hand, welding fumes are not generated, so there can be no generation of greenhouse effect gas such as carbon dioxide.

In the above embodiment, it was explained that the cylindrical column jacket 3 was formed from a mild steel tube. However, the cylindrical column jacket may be formed from an Al—Mn alloy tube instead of a mild steel tube. Similarly to the above embodiment, the joint projections are formed on the mild steel distance bracket and the projections are crimped into the Al—Mn alloy column jacket.

In such a steering column, it is possible to decrease the whole weight of the steering column assemble by the aluminum alloy column jacket which is lighter than the mild steel column jacket, decreasing the vehicle weight.

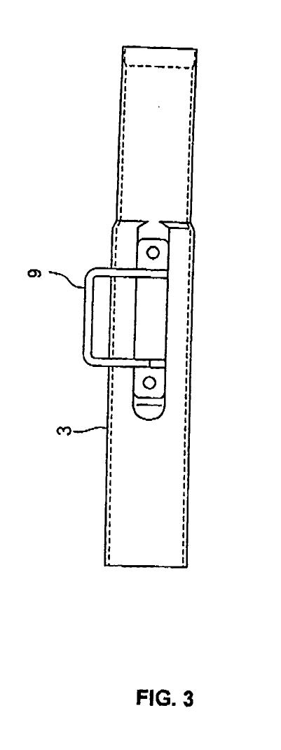

Hereunder is a description of an embodiment which is different from the above. This embodiment is an application example for an upper bracket for fixing to a body member. In FIG. 3, an upper bracket 9 for fixing to a body member is mounted on the column jacket 3.

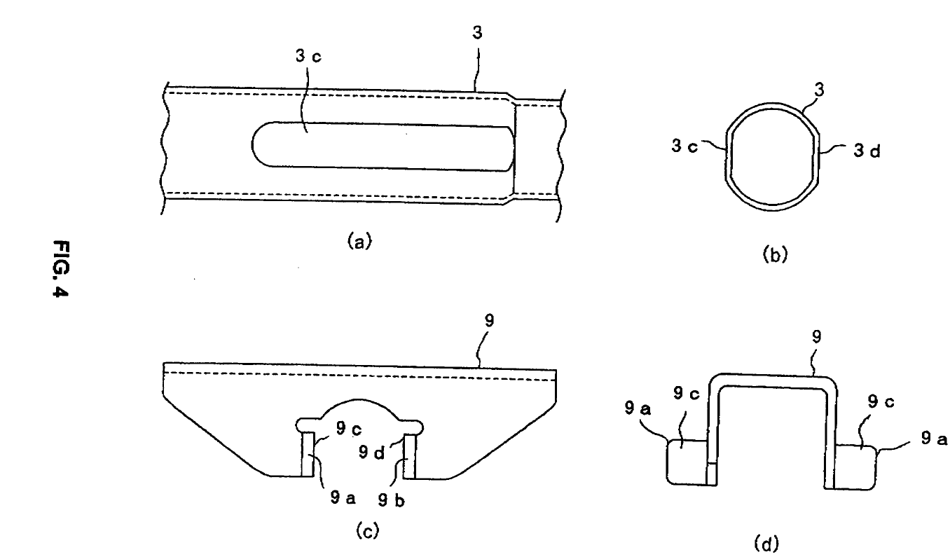

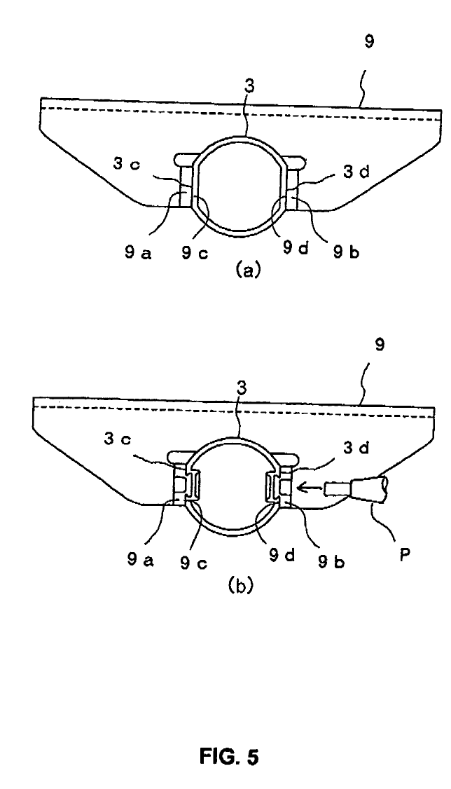

Hereunder is a description of a method of assembling a steering column based the schematic diagram shown in FIG. 4 and FIG. 5. An electric resistance welded mild steel tube or a drawn tube is cut in a predetermined length to form the cylindrical column jacket 3. As shown in FIGS. 4(a) and (b), while supporting the inner surface by a die (not shown), the opposed outer surfaces are pressed by a punch (not shown) to form a pair of flat surfaces 3c and 3d back to back.

As shown in FIGS. 4(c) and (d), a mild steel plate is prepared and press processed into the upper bracket 9 comprising a pair of joint projections 9a and 9b. The pair of projections 9a and 9b are symmetrically formed as two sets with respect to the center of the upper bracket, so as to protrude outwards. Inner surfaces 9c and 9d of the projections 9a and 9b are formed in a flat shape conforming to the flat surfaces 3c and 3d of the column jacket 3.

As shown in FIG. 5(a), the upper bracket 9 having the projections 9a and 9b is fitted to the column jacket 3 which was previously processed. In the present step, the inner surfaces 9c and 9d of the projections 9a and 9b are fitted along the flat surfaces 3c and 3d of the column jacket 3. After assembling, they are temporary fixed using a suitable clip so that the position of both members does not change accidentally.

As shown in FIG. 5(b), while supporting the inner surface of the column jacket 3 by a die (not shown), the outer surfaces of the projections 9a and 9b of the upper bracket 9 are crimped by applying a punch P. In the present step, these are crimped with the punch P which is pressed toward the center of the column jacket 3 so as not to deform the circular cross-section column jacket 3.

By the above procedure, the steering column having the upper bracket 9 mounted thereon (refer to FIG. 3) is obtained.

In the present embodiment, particularly the positioning during the crimping process is well maintained by the flat surfaces 3c and 3d of the column jacket 3 and the flat inner surfaces 9c and 9d of the projections 9a and 9b of the upper bracket 9, and hence the joint strength can be kept stable.

In the above embodiment, it was explained that the cylindrical column jacket 3 was formed from a mild steel tube. However, the cylindrical column jacket may be formed from an Al—Mn alloy tube instead of a mild steel tube.

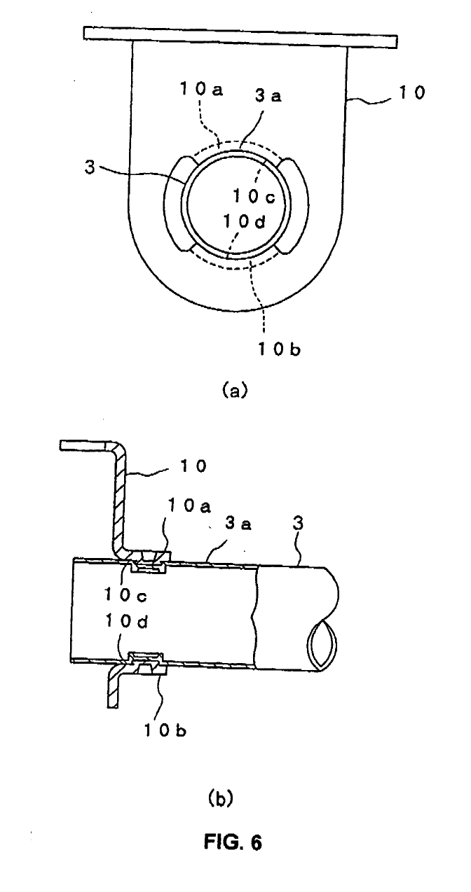

Hereunder is a description of an embodiment which is different from the above. This embodiment is an application example for a lower bracket for fixing to a body member. In FIGS. 6(a) and (b), a lower bracket 10 for fixing to a body member is mounted on the column jacket 3. The lower bracket 10 comprises a pair of joint projections 10a and 10b. The pair of joint projections 10a and 10b are formed on the lower bracket 10 in a similar procedure to the method described in the above embodiments. That is, the pair of projections 10a and 10b are symmetrically formed with respect to the center of the lower bracket, so as to extend from the side face. Inner surfaces 10c and 10d of the projections 10a and 10b are formed in a circular arc shape conforming to the outer surface 3a of the column jacket 3.

The lower bracket 10 having the projections 10a and 10b is fitted to the column jacket 3 which was previously processed. In the present step, the inner surfaces 10c and 10d of the projections 10a and 10b are fitted along the outer surface 3a of the column jacket 3. After assembling, they are temporary fixed using a suitable clip so that the position of both members does not change accidentally.

While supporting the inner surface of the column jacket 3 by a die (not shown), the outer surfaces of the projections 10a and 10b of the lower bracket 10 are crimped by applying a punch (not shown).

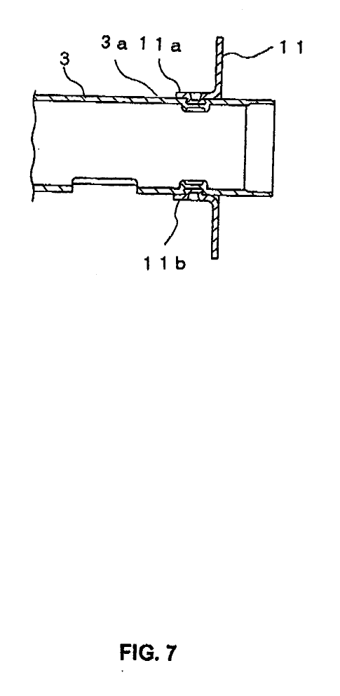

Hereunder is a description of an embodiment which is different from the above. This embodiment is an application example for a bracket for attaching a combination switch. In FIGS. 7(a) and (b), a bracket 11 for attaching a combination switch is mounted on the column jacket 3. The bracket 11 comprises a pair of joint projections 11a and 11b. The pair of projections 11a and 11b are formed on the bracket 11 in a similar procedure to the method described in the above embodiments. That is, the pair of projections 11a and 11b are symmetrically formed with respect to the center of the bracket, so as to protrude from the side face. Inner surfaces 11c and 11d of the projections 11a and 11b are formed in a circular arc shape conforming to the outer surface of the column jacket 3.

The bracket 11 having the projections 11a and 11b is fitted to the column jacket 3 which was previously processed. In the present step, the inner surfaces of the projections 11a and 11b are fitted along the outer surface of the column jacket 3. After assembling, they are temporary fixed using a suitable clip so that the position of both members does not change accidentally.

While supporting the inner surface of the column jacket 3 by a die (not shown), the outer surfaces of the projections 11a and 11b of the bracket 11 are crimped by applying a punch (not shown).

### INDUSTRIAL APPLICABILITY

As described above, the method according to the present invention, of assembling a steering column, is one where when fixing the bracket to the steering column, the bracket is fixed by crimping the joint projections which are integral with the bracket main body, which is effective in not increasing the number of steps and the number of components, and in keeping the manufacturing cost from increasing. Moreover, it is effective in that it is not necessary to strictly control the accuracy of the bracket, so that the bracket can be manufactured at low cost.

1. A method of assembling steering columns, comprising the steps of:
forming a cylindrical column jacket;
forming a pair of joint projections comprising inner surfaces in a circular arc shape conforming to an outer surface of said column jacket on a bracket;
temporary fitting said projections of said bracket along the outer surface of said column jacket; and
crimping said projections into the outer surface of said column jacket.

2. A method of assembling steering columns, comprising the steps of:
forming a cylindrical column jacket;
forming a pair of flat surfaces back to back on an outer surface of said cylindrical column jacket;
forming a pair of joint projections comprising flat inner surfaces conforming to the pair of flat surfaces of said column jacket on a bracket;
temporary fitting said projections of said bracket along the flat surface of said column jacket; and
crimping said projections into the flat surface of said column

3. A method of assembling steering columns according to claim 1 or claim 2, wherein in forming said a pair of joint projections, said projections are symmetrically formed with respect to the center of said bracket.

4. A method of assembling steering columns according to claim 1 or claim 2, wherein in crimping said projections, these are crimped with a punch which is pressed toward the center of said column jacket.

5. A method of assembling steering columns according to claim 1 or claim 2, wherein in forming said column jacket, a cylindrical column jacket is formed from a mild steel tube.

6. A method of assembling steering columns according to claim 1 or claim 2, wherein in forming said column jacket, a cylindrical column jacket is formed from an Al—Mn alloy tube.
